(19) United States
(12) Patent Application Publication
(10) Pub. No.: US 2026/0191210 A1
(43) Pub. Date: Jul. 9, 2026

(54) SHAPED PATTY MAKER

(71) Applicant: Oded Rom, Yahud-Monoson (IL)

(72) Inventor: Oded Rom, Yahud-Monoson (IL)

(21) Appl. No.: 19/553,452

(22) Filed: Mar. 2, 2026

Related U.S. Application Data
(63) Continuation-in-part of application No. PCT/IL2024/050819, filed on Aug. 14, 2024.
(60) Provisional application No. 63/536,498, filed on Sep. 5, 2023.

(51) Int. Cl. A22C 7/00

(52) U.S. Cl. CPC A22C 7/0084; A22C 7/0038

(57) ABSTRACT

A hand-held patty maker with various molds that allows for contact-free patty making. The patty maker may be operated with a single hand, for example, one hand holds the patty maker and the other hand stuffs a food mixture into the container to form a shaped patty. A single handle may be used to interconnect between different shaped molds and pusher plates to make and eject different shaped patties. The molds may be filled to produce patties of the same size.

### RELATED APPLICATIONS

This application is a Continuation in Part of International Patent Application no. PCT/IL2024/050819, filed on 14 Aug. 2024, which claims the benefit of priority under 35 USC § 119(e) of U.S. Provisional Ser. No. 63/536,498 filed Sept. 5, 2023, the contents of which are incorporated herein by reference in their entirety.

### FIELD AND BACKGROUND OF THE INVENTION

The present invention in some embodiments thereof relates to a shaped patty maker and, more particularly, but not exclusively, to a hand-held food-mixture patty maker with various molds.

A glance at the frozen-food options in the local supermarket shows the popularity of molded and shaped processed foods. There are families who prefer to prepare food at home, but also want their children and guests to enjoy food that has been formed into patties of pleasing and/or entertaining shapes. Hand-forming the food is time-consuming, messy, and does not produce a similar patties'shape, weight, size and thickness.

Israeli Patent no. IL199868 by the present inventor appears to relate to “An apparatus for shaping croquettes, including: a vessel, the inner space thereof being used for shaping dough into a croquette; a piston, movable in said vessel, for pushing said croquette out of said vessel; a lever, for applying force! a transmission, for transmitting said force to said piston; wherein the movement direction of said lever is substantially perpendicular to the movement direction of said piston; or wherein the size of said apparatus is suitable to be operated by a human palm; or wherein said force is applied by a motor.”

Various hamburger presses and molds are available on Amazon and eBay, etc. most include a press and a mold with a single shape, require two handed operation, or are difficult to extract the pressed patty from the mold.

### SUMMARY OF THE INVENTION

According to an aspect of some embodiments of the invention, there is provided a patty maker including: a mold configured to shape a mixture into a patty including a distal opening for accepting the mixture; a pusher plate shaped and sized to fit within the mold; and a handle protruding proximally from the mold and reversibly interconnecting between mold and the pusher plate, the handle having an inactivated configuration wherein the handle retains the pusher plate in a proximal portion of the mold and the handle configured to be held in one hand and activated is the one hand to extend the pusher plate distally pushing the mixture out of the distal opening of the mold.

According to some embodiments of the invention, the mold includes a support with configured to reversibly connect to the handle.

According to some embodiments of the invention, the support rigidly connects to a mount on the handle for holding the mold via the handle.

According to some embodiments of the invention, attachment between the mount and the support includes at least one attachment mechanism selected from the group consisting of a screw thread, friction element, click on interference element, magnet, snap connector, or a combination thereof.

According to some embodiments of the invention, the support includes an opening configured for passage of a connection between the pusher plate and the handle.

According to some embodiments of the invention, the handle includes a connector and the pusher plate includes a coupler and wherein the connection is between the connector and the coupler.

According to some embodiments of the invention, the coupler extends proximally from the pusher plate.

According to some embodiments of the invention, the pusher plate includes a coupler extending proximally perpendicular to a back face of the pusher plate.

According to some embodiments of the invention, the coupler is attached to n extender configured to pass through an opening in the mold.

According to some embodiments of the invention, the handle includes at least two levers.

According to some embodiments of the invention, the at least two levers interconnect between the pusher plate and the mold.

According to some embodiments of the invention, the at least two levers are configured to bias the pusher plate proximally within the mold.

According to some embodiments of the invention, the at least two levers interconnect between a coupler and a mount.

According to some embodiments of the invention, the levers are configured to be elastically biased to retract the coupler proximally.

According to some embodiments of the invention, the mount is reversibly attached to a support on the mold.

According to some embodiments of the invention, the coupler is reversibly connected to a connector on the pusher plate.

According to some embodiments of the invention, the connector is reversibly attached to the coupler by a connection element selected from the group consisting of: a grasping element that grasps connector, friction element, click on interference element, screw thread, magnet, snap connector, or any combination thereof.

According to some embodiments of the invention, the mold includes one or more projections configured to produce hollows in the patty.

According to some embodiments of the invention, the pusher plate includes holes matching the projections of the mold.

According to some embodiments of the invention, a shape of the pusher plate matches the shape of the mold.

According to some embodiments of the invention, the pusher plate includes a stencil configured to stamp a pattern into an upper face of the patty.

According to an aspect of some embodiments of the invention, there is provided a method of preparing a patty including: supplying mold with a distal opening and a pusher plate positioned distally in the mold and a handle projecting proximally from the mold and interconnecting between the mold and the pusher plate: inserting a food-mixture into the distal opening of the mold; and activating the handle to press the pusher plate towards the distal opening of the mold, thereby pushing the patty out of the mold.

According to some embodiments of the invention, the food-mixture is a foodstuff, the method further including preparing the foodstuff.

According to some embodiments of the invention, the supplying includes placing a pusher plate within a mold.

According to some embodiments of the invention, the supplying includes reversibly attaching the pusher plate and the mold to the handle.

According to some embodiments of the invention, the activating includes squeezing at least two levers together thereby moving the pusher plate proximally away from the levers.

According to some embodiments of the invention, the handle is actuated to push the pusher plate by a force perpendicular to movement of the pusher plate.

According to some embodiments of the invention, the handle is designed for holding the mold and activating the handle with one hand.

### DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B: Schematic illustrations of perspective views of a handle, in accordance with an embodiment of the current invention.

FIGS. 2A-2C: Schematic view of various components of a system, in accordance with an embodiment of the current invention.

FIGS. 3A and 3B: Schematic illustrations of the shaped container including the pusher plate, in accordance with an embodiment of the current invention.

FIGS. 4A-4D: Schematic illustrations of the various components of a system, in accordance with an embodiment of the current invention.

FIG. 5 is a flow chart illustrating use of an interchangeable handle in accordance with an embodiment of the current invention.

FIGS. 6A-6C: Schematic illustrations of the various components of a system, in accordance with an embodiment of the current invention.

FIGS. 7A-7B are schematic illustrations of a system in accordance with an embodiment of the current invention.

FIG. 8: Block diagram illustrating an embodiment of the current invention.

FIG. 9: Flow chart of a method of forming shaped patties in accordance with an embodiment of the current invention.

FIG. 10: Flow chart of a method of forming shaped patties in accordance with an embodiment of the current invention.

### DESCRIPTION OF SPECIFIC EMBODIMENTS OF THE INVENTION

The present invention in some embodiments thereof relates to a shaped patty maker and, more particularly, but not exclusively, to a hand-held food-mixture patty maker with various molds. that allows for contact-free patty making. Alternatively, or additionally, the patty maker may be operated with a single hand, for example, one hand holds the patty maker and the other hand stuffs the-mixture into the container to form the shaped patty. In some embodiments, the patty maker may be easy to use and/or facilitates extraction of the pressed patty without touching the patty and/or provides multiple shaped molds and/or may be used with a variety of materials and/or a variety of foods.

### OVERVIEW

The present invention in some embodiments thereof relates to a shaped patty maker and, more particularly, but not exclusively, to a hand-held patty maker with various molds that allows for patty making.

The current invention in some of its embodiments may possess some or all of the following advantages: it may facilitate forming the patties into various shapes using a variety of molds, patterns, etc. ; it may be simple and/or easy to swap between shaped containers of different shapes and/or sizes; the system may facilitate one-handed use; and/or it may facilitate forming patties without touching the patties by hand. For example, one hand holds the patty maker and the other hand stuffs the-mixture into a container to form the shaped patty. Optionally, the container may be stuffed by hand, using a kitchen tool (e.g., spoon, spatula, etc.). Optionally, the system may be configured for ejection of a patty without touching the mixture with by hand. Optionally, the system may be configured for ejection of a patty without touching the mixture with by any other instrument. A container may be configured to form a patty of a predefined shaped. Such a container may be called a mold.

According to some embodiments, shaped patty maker system may include a handle, an outer shaped container (e.g., mold), and an inner pusher plate. Optionally, the system may be configured to facilitate one handed control, e.g., to hold the shaped container and push out the patty. Optionally, the mold includes a support (e.g., a connection mechanism) for connection to the handle (e.g., a mount on the body of the handle). Optionally, the pusher plate includes a coupling.

According to some embodiments, the handle may include a body, a connector, and one or more levers. Optionally, the levers may be triangular. Optionally, the connector may be located in the center of the body. Optionally, the levers may be linked to the connector. Optionally, the levers may be supported by the body. Optionally, the levers may be configured to fold and/or move the towards the center of the body and/or push the connector to an extended position. For example, the handle may be folded and/or the connector moved to the extended position when the handles are pressed and/or squeezed together. Squeezing the handles together optionally moves the connector to the extended position. For example, in the extended position the connector may move towards the body and/or to protrude through the center of body. Optionally, the levers may be biased to a retracted position when the pressure is released, thereby retracting the connector from the center of the body.

According to some embodiments, the handle may include one or more biases which may be configured to pull the connector and/or a pusher plate inward (e.g., to a retracted position). Optionally, the biases may be elastically biased to spread the levers of the handle outward. Optionally, the biases may be elastically biased to retract the pusher plate towards the handle and/or toward the base of the mold and/or toward the support of the mold.

According to some embodiments, moving the connector and/or the pusher plate to the extended position may push the patty out of the shaped container (mold). For example, squeezing the handle may cause a pair of triangular levers to push the connector and/or pusher plate. Optionally, pushing the handles together may push the connector perpendicular to the pusher plate thereby creating a greater space between the pusher plate and the proximal end of the handle. In some embodiments, the body of the handle is fixed (e.g., by a screw thread, magnet, snap connector, etc.) to the shaped container. Optionally, activating (e.g., squeezing) the handle may cause the pusher plate to move distally, thereby pushing out the patty.

According to some embodiments, the handle may be configured for connection to the shaped container and/or pusher plate. Optionally, the handle may reversibly connect to the shaped container and/or pusher plate. Optionally, the handle body may be reversibly connectable to the shaped container e.g., by a screw thread, friction element, click on interference element, magnet, snap connector, etc. Optionally, the connector may reversibly connect to the pusher plate, e.g., by a grasping element that grasps a coupling of the pusher plate, a friction element, an interference element, a click connector, a screw thread, a magnet, a snap connector, etc. or any combination thereof. Alternatively, or additionally, the handle may be permanently connected to the shaped container and/or pusher plate.

According to some embodiments, the shaped container may include a base and/or side walls. Optionally, the base may be a solid wall and/or an open grille and/or a windowed wall etc. Alternatively or additionally, there may be no back surface. For example, the pusher plate may be the only back surface of the mold. In some cases, the mold without a back surface may be easier to clean that a mold with a back wall. Optionally, the mold (e.g., the back thereof and/or the surface distal to the patty) may include a support for connection to the handle. Optionally, the support may include an attachment mechanism for a mount on the handle. Optionally, the attachment mechanism may connect to the body of the handle. Optionally, the attachment mechanism may connect to the body of the handle by a means including a screw thread, friction element, click on interference element, magnet, snap connector, etc. or any combination thereof. Optionally, the support and/or the mount may include a hole. For example, the hole may be in the center thereof. Optionally, the hole in the support and/or mount may be configured to facilitate passage of the handle connector and/or coupler of the pusher plate. Optionally, the connector of the handle and/or coupler of the pusher plate may protrude through the hole.

According to some embodiments, the shaped container may have a variety of shapes, e.g., star, heart, circle, cloud, triangle, logo, etc. Optionally, the shaped container may be configured to fit the pusher plate. Optionally, the system may include multiple shapes for the shaped container. Optionally, it may be simple and/or easy to swap between shaped containers of different shapes and/or sizes. Optionally, the shaped container may be configured to accept foodstuff. Optionally, the shaped container may be configured to accept a standard portion size of the foodstuff. Optionally, the shaped container may be filled by the user, e.g., by hand or using a kitchen utensil. Optionally, the shaped container may be pressed into a foodstuff. Optionally, the shaped container may be configured for cutting a foodstuff, e.g., food-mixture, etc.

According to some embodiments, the shaped container may include one or more projections. Optionally, the projections may be configured to produce hollows in the patty (e.g., the eyes and mouth of a smiley face).

According to some embodiments, the pusher plate may include a front face in contact with the foodstuff, and a back face in contact with the shaped container. Optionally, the pusher plate may be designed to fit exactly within the shaped container. Optionally, the pusher plate may be designed with the same shape as the shaped container, e.g., star, heart, circle, cloud, triangle, logo, etc. Optionally, the pusher plate may include holes that fit around the projections of the shaped container. Optionally, the face of the pusher plate may be configured to act as a stamp e.g., have a stencil pattern projecting outward that forms a pattern stamped into the upper face of the foodstuff (e.g., a star, letters, etc.).

According to some embodiments, the back face of the pusher plate may include a plate coupler. Optionally, the plate coupler may be perpendicular to the back face. Optionally, the plate coupler may reversibly connect to the handle connector, e.g., by a grasping element that grasps connector, friction element, click on interference element, screw thread, etc. Optionally, the plate coupler may be configured to fit within and/or pass through the hole in the shaped container. Optionally, the pusher connector may protrude through the hole.

According to some embodiments, the pusher plate may be configured to push the patty out of a shaped container perpendicular to the pusher plate. Optionally, the handle may be actuated to push the pusher plate by a force perpendicular to the movement of the pusher plate.

According to some embodiments, the system and/or components thereof may be composed of a variety of materials, e.g., metal, plastic, glass, ceramic, silicone, aluminum, tin, stainless steel, etc. Optionally, the system and/or components thereof may be easy to assemble and/or disassemble. Optionally, the system and/or components thereof may be easy to clean.

According to some embodiments a mold and pusher plate and/or a set of different molds (e.g., each mold of a set of molds of different shapes may be configured to all have the same volume) and pusher plates are configured to hold a fixed quantity of the mixture. For example, to get set of even sized patties, the user may fill a mold with a mixture and/or push out the patty. Each patty may include the same quantity of mixture and/or have the same thickness. For example, a mold may have a volume ranging between 5 to 10 cm³ and/or 10 to 30 cm³ and/or between 30 to 60 cm³ and/or between 60 to 120 cm³ and/or between 120 to 500 cm³. Optionally the patties may have a thickness ranging between 1 to 3 cm and/or between 0.2 to 1 cm and/or between 3 to 8 cm. Optionally the patties may have a horizontal dimension ranging between 1 to 3 cm and/or between 0.2 to 1 cm and/or between 3 to 8 cm. Optionally, the patty may have a mass between 10 to 50 g and/or between 50 to 200 g and/or between 200 to 500 g.

In some embodiments, the system may be used with a variety of formable materials and/or foodstuffs. Non-limiting examples of suitable materials include: mixtures of food such as beef, chicken, fish, various fruit and vegetables, herbs, spices, or any combination thereof. Optionally, the system may be used to produce a meat-based patty, a vegetarian-based patty, a vegan based patty, and/or any combination thereof from which a patty may be produced. Optionally, the foodstuff may undergo preparation prior to use in the system, e.g., chopped, ground, mashed, mixed, etc. Optionally, the foodstuff may be raw, partially cooked and/or cooked prior to use in the system. Optionally, the system may be used in the manufacture of patties, latkes, pancakes, cookies, etc.

According to some embodiments, the system may be used as a cookie cutter. For example, the shaped container may be used to cut a specific shape in rolled out dough. Optionally, the cut shape may include hollows (e.g., from the protrusions in the shaped container and/or the pusher plate). Optionally, the cut shape may include a pattern stamped on its upper surface (e.g., from a pattern on the pusher plate). Optionally, pressing the levers on the handle may press an image from the pusher plate into the mixture. Optionally, pressing the levers on the handle may assist in removing the cut shape from the shaped container (e.g., mixture tends to stick in the molds and the shape can deform on extraction from the mold).

According to some embodiments, the system may be configured such that squeezing the handle may push the patty out of the shaped container. Optionally, foodstuff may be loaded into a shaped container with a pusher plate inserted and connected to a handle. Alternatively or additionally, the handle may include a part that is held by the fingers while pushing a button, lever and/or surface with the thumb to extend the pusher plate outward and/or release the patty. Optionally, the foodstuff may be in a vessel, the shaped container may be pressed into it. Optionally, the levers may be pressed to lower the pusher plate, thereby extracting the shaped foodstuff. Optionally, the system may be placed on a flat surface (e.g., a cleaned countertop, cutting board, wax paper covered surface, etc.) and the levers pressed and/or partially pressed to lower the pusher plate compress the patty and/or impress a pattern into a surface of the shaped foodstuff. The shaped foodstuff may then be extracted by further depressing the levers and/or lifting the system up off the surface.

According to some embodiments, the system may facilitate one-handed use. Optionally, the system may facilitate forming patties without physical contact between the foodstuff and the user. Optionally, the system may facilitate forming patties without hands touching the patties (hands-free patty making), for example, by pressing the shaped container. onto a flat mass of the foodstuff (e.g., a paste) and/or squeezing a handle to eject a patty from the shaped container. Alternatively, or additionally, the foodstuff may be manually placed inside the shaped container.

According to some embodiments, the width of the shaped container and/or pusher plate, and/or patty may range between about 3 cm to about 6 cm, between about 6 cm to about 12 cm, and/or between about 12 cm to about 20 cm. In some embodiments, the length of a shaped container and/or pusher plate, and/or patty may range between about 3 cm to about 6 cm, between about 6 cm to about 12 cm, and/or between about 12 cm to about 20 cm. In some embodiments, the depth of a shaped container and/or patty may range between about 0.1 cm to about 0.5 cm, and/or between about 0.5 cm to about 1.5 cm, and/or between about 1.5 cm to about 5 cm, and/or between about 5 cm to about 10 cm. In some embodiments, a patty may weigh between about 10 g to about 50 g, and/or between about 50 g to about 200 g, and/or between about 200 g to about 500 g.

### SPECIFIC EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

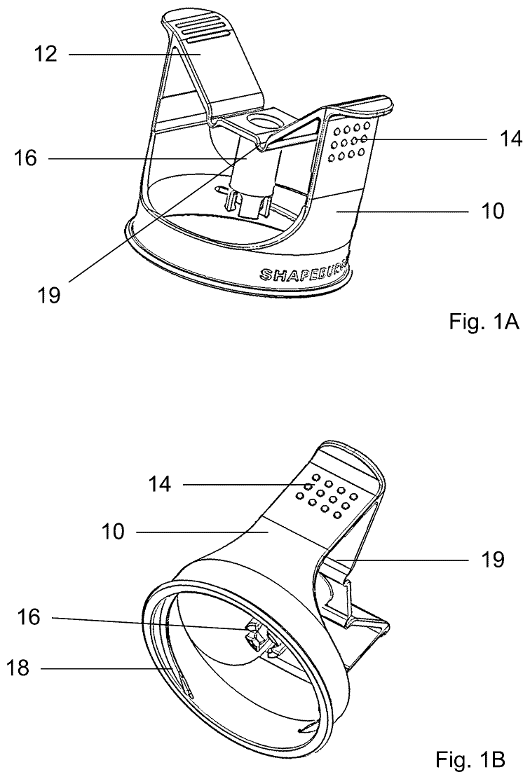

FIGS. 1A and 1B are schematic illustrations of perspective views of a handle, in accordance with an embodiment of the current invention. For example, the handle may include a body 10. Body 10 may be attached to one or more levers 12. Optionally the levers are linked to a connector 16. For example, one or more hinges 19 may attach the levers 12 to the connector 16. Optionally, connector 16 may include a grasping element, and/or friction element, and/or click-on interference element, etc. Body 10 may include finger grips 14 on a or more outer surfaces. Body 10 may include an attachment mechanism (e.g., mount 18) (e.g., by screw thread) for attachment to a support (not shown) on the back of a shaped container (e.g., mold), The handle may include one or more biases which may be elastically biased to spread the levers 12 of the handle to retract the levers 12. For example, levers 12 and/or the grips 14 and/or the body 10 may be elastically biased outward pulling proximally on hinges 19 and/or connector 16. Optionally, the biasing may retract the connector 16 proximally within the and/or away from body 10 of the handle.

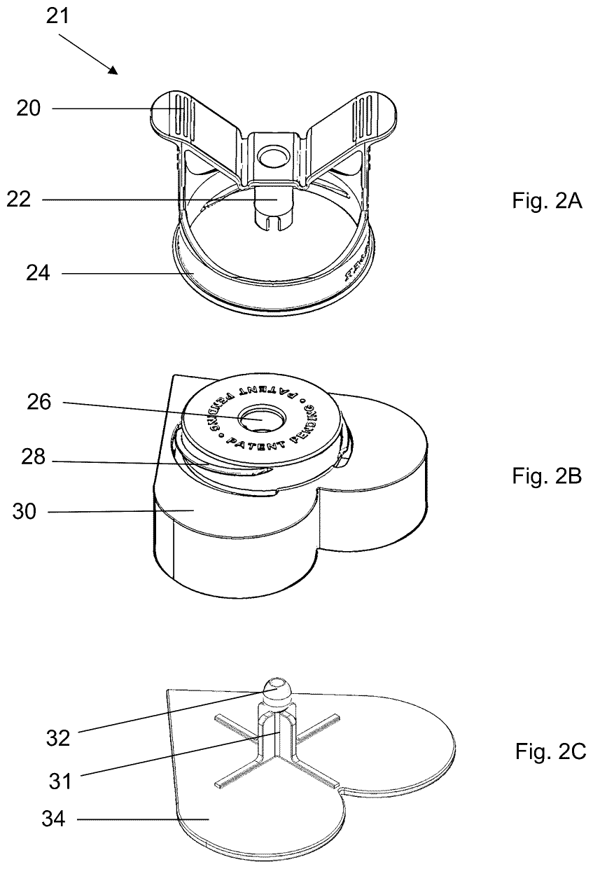

FIGS. 2A-C are a schematic view of various components of a system, in accordance with an embodiment of the current invention. For example, the system may include: a handle 21, a shaped container 30, and a pusher plate 34. Optionally, handle 21 may include one or more levers 20 and a connector 22. Handle 21 may include one or more biases which may be elastically biased to spread the levers 20 of the handle outward. Optionally, the biases may be elastically biased to retract the connector 22 proximally within the body of the handle.

Shaped container 30 may include a support 28 with an attachment mechanism (e.g., by screw thread, magnet, snap connector, etc.) configured for attachment to the body 24 of handle. Support 28 may include an opening 26. Optionally, the handle connector 22 and/or the pusher coupler 32 may pass through hole 26 as they are extended to release a patty.

Pusher plate 34 may include a pusher coupler 32. For example, coupler 32 may be attached to a back face of the pusher plate 34. Optionally, pusher coupler 32 may be connected to a proximal portion and/or proximal end of an extender 31 projecting distally perpendicular to the back (proximal) face of pusher plate 34. Optionally, pusher coupler 32 may connect to handle connector 22. For example, the connection may be via a grasping element that grasps the coupler 32, friction element, click on interference element, screw thread, magnet, snap connector, etc.

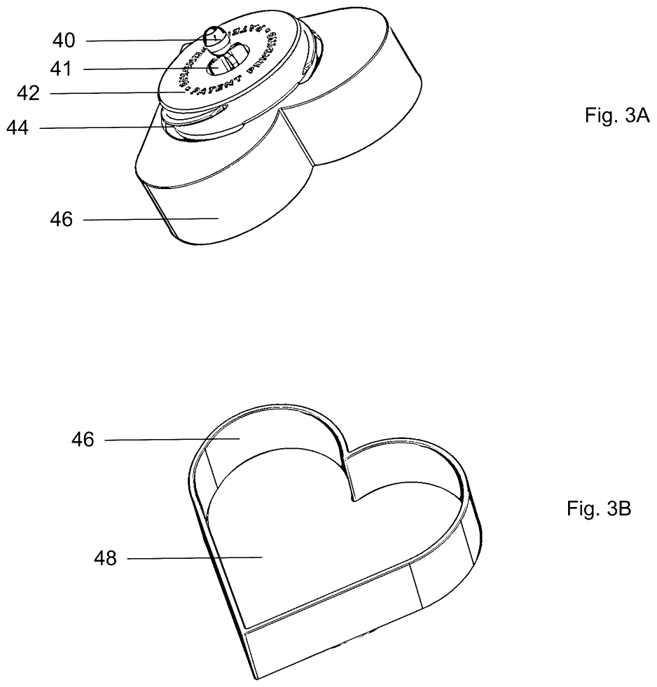

FIGS. 3A and 3B are schematic illustrations of the shaped container 46 including the pusher plate 48, in accordance with an embodiment of the current invention. For example, shaped container 46 may include a support 42 with an attachment mechanism 44 (e.g., by screw thread, magnet, snap connector, etc.) configured for attachment to a mount on the body of handle. Support 42 may include an opening 41, through which the pusher coupler 40 may pass. Pusher plate 48 may include a pusher coupler 40 on its back face.

According to some embodiments, the system may include various shaped containers. For example: heart-shaped, star-shaped, smiley-face, etc. Optionally, the shaped containers may serve as a container to contain the prepared food into the shape of the shaped container. Optionally, the pusher plate may be shaped to fit the shaped container. Optionally, the pusher plate may be shaped to fit within the shaped container.

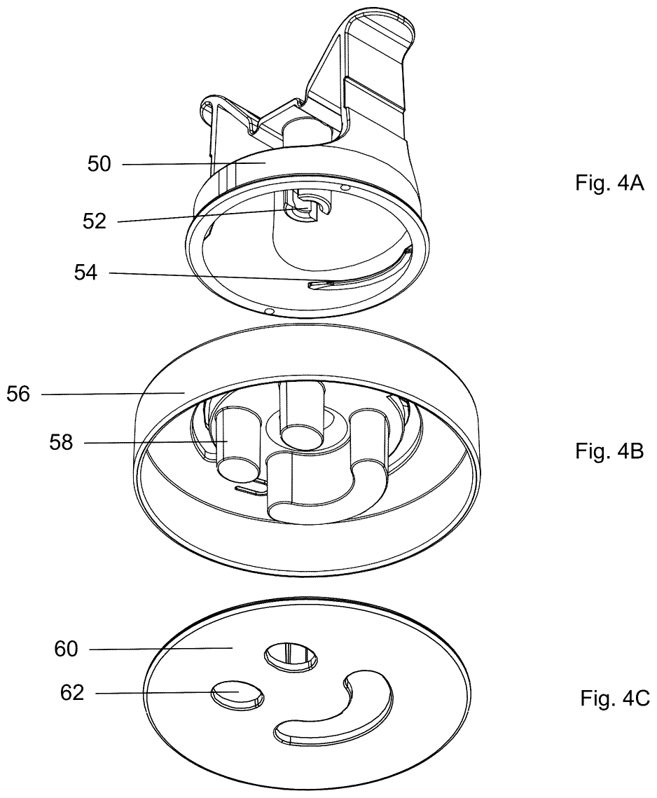

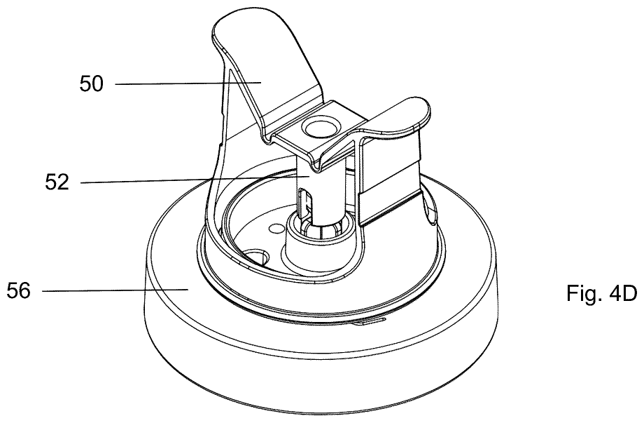

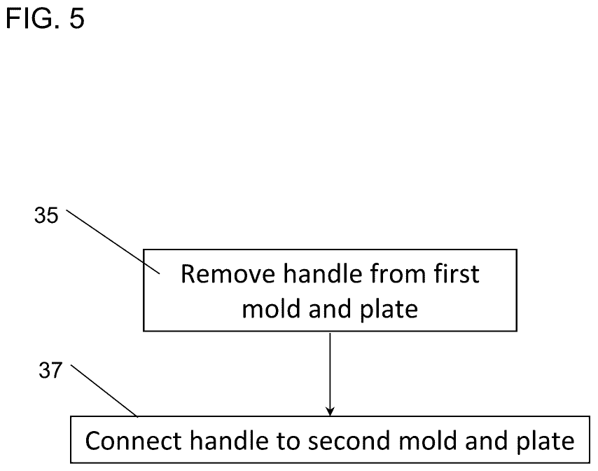

FIGS. 4A-4D are schematic illustrations of the various components of a system, in accordance with an embodiment of the current invention. For example, FIGS. 5A-C show various exemplary components of the system disassembled, and FIG. 5D show various exemplary components of the system assembled. Optionally, the system may be easy to assemble and/or disassemble, and/or clean. For example, the system may include: a handle 50, a shaped container 56, and/or a pusher plate 60. Optionally, handle 50 may include a mount 54 which may include an attachment mechanism (e.g., a screw thread, magnet, snap connector, etc.) for connection to the shaped container 56. Optionally, handle 50 may include a connector 52 for connection to pusher plate 60 e.g., the coupler thereof. Optionally, shaped container 56 may include one or more projections 58. Optionally, projections 58 may be configured to produce hollows in the foodstuff (e.g., the eyes and mouth of a smiley face). Optionally, pusher plate 60 may include openings and/or holes 62 through which the shaping projections 58 of shaped container 56 pass. For example, the holes 62 may match the projections 58.

FIG. 5 is a flow chart illustrating use of an interchangeable handle in accordance with an embodiment of the current invention. In some embodiments, a single handle may be reversibly attached to various pairs of mold and pusher plates. Optionally, the handle may be used to hold a first mold and/or push a first pusher plate (e.g., pushing a patty out of the first mold). For example, the handle may be detached 35 from a first mold and/or from a first pusher plate. Then a second mold and pusher plate having a different size or shape may be attached 37 to the handle. Optionally, the handle used to hold the second mold and/or push the second pusher plate with respect to the mold thereby forming and/or ejecting a patty. For example, the handle of FIGS. 1A and 1B may interchangeably be attached and/or detached from container 30 and/or plate 34 and/or container 46 and/or container 56 and/or plate 60 and/or container 74 and/or plate 72.

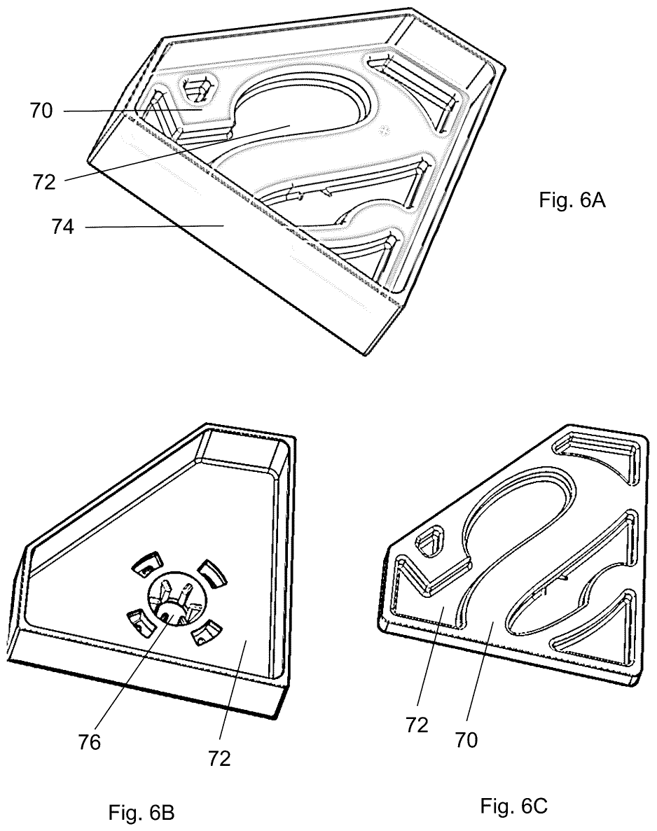

FIGS. 6A-C are schematic illustrations of the various components of a system, in accordance with an embodiment of the current invention. For example, the system may include various shaped containers 74 and/or pusher plates 72. Optionally, pusher plate 72 may be shaped to match the container 74. For example, the pushing plate may fit precisely into shaped container 74 (e.g., the clearance between the edges of the pusher plate and the walls of the container may be less than 0.1 mm and/or between 0.1 to 0.5 mm and/or between 0.5 mm to 1 mm and/or between 1 to 2 mm and/or between 2 to 5 mm. Optionally, pusher plate 72 may be shaped like and/or shaped to fit within shaped container 74. Optionally, the pusher coupler is positioned to fit through an opening in the back of the container 74. Optionally, the pusher plate 72 includes holes positioned and/or matching projections of the container. Optionally, a pusher connector (not shown) may pass through an opening 76 in shaped container 74. Optionally, the front face of the pusher plate 72 may be configured to act as a stamp e.g., have a stencil 70 pattern projecting outward that forms a pattern stamped into the upper face of the foodstuff (e.g., a star, letters, etc.).

In some embodiments, the system may include a stamp. Optionally, when the device is used to make a patty, the stamp may emboss a shape onto a surface of the patty. For example, the stamp may include a protrusion and/or a depression. Optionally, the stamp will produce an opposing protrusion and/or depression on the face of the patty. For example, the stamp may be on the face of a pusher plate and/or may emboss a shape onto an upper face of the patty.

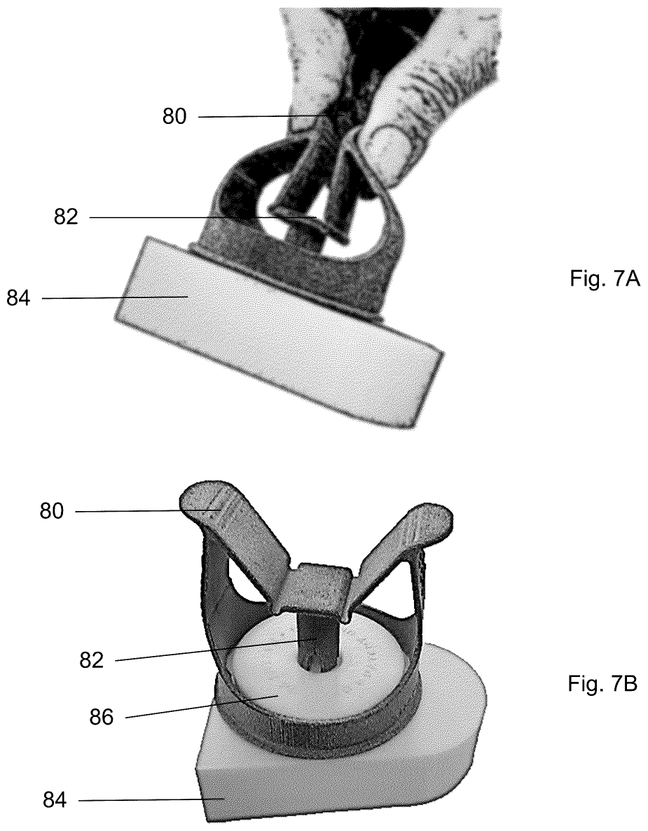

FIGS. 7A-B are schematic illustrations of a system in accordance with an embodiment of the current invention. For example, FIG. 7A illustrates a handle in an extended configuration (e.g., pushing a pusher plate distally and/or releasing a patty. For example, FIG. 7B illustrates a handle in a retracted configuration e.g., for loading and/or holding a patty in the container 84. For example, a user may activate the system (e.g., move it to cause the inner pusher plate to push out the formed patty). In some embodiments, squeezing the handle may cause a pair of triangular levers 80 to push the patty out of the shaped container 84. Optionally, squeezing the levers 80 together may push the connector 82 perpendicular to the pusher plate (not shown) thereby creating a greater space between the pusher plate and the proximal end of the handle. Optionally the handle is fixed (e.g., mount to a support on the mold, e.g., by a screw thread, magnet, snap connector, etc.) to the shaped container 84 by a connection mechanism 86, the pusher plate may be forced distally, thereby pushing out the patty. Optionally, the handle is elastic such that the pusher plate returns automatically to a biased position. For example, the levers 80 may be designed to bias the pusher plate to the retracted position.

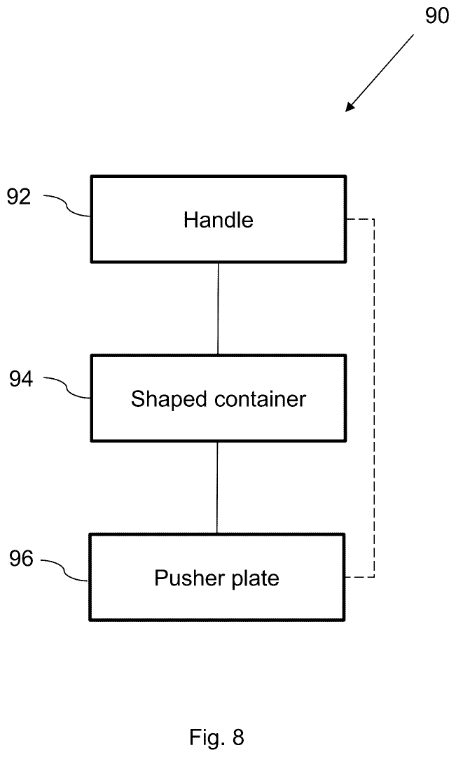

FIG. 8 is a block diagram illustrating an embodiment of the current invention. For example, system 90 includes a handle 92, a shaped container 94, and a pusher plate 96. Optionally, handle 92 may interconnect the pusher plate 96 and the container 94. For example, the handle may bias the pusher plate 96 to a retracted state. For example, in the retracted state, the pusher plate 96 may be retracted proximally into the container 94 facilitating filling the container 94 with a mixture to form a patty. In some embodiments, the handle is configured for one handed ejection of the patty, for example, by extending the pusher plate distally towards and/or out a distal opening of the container.

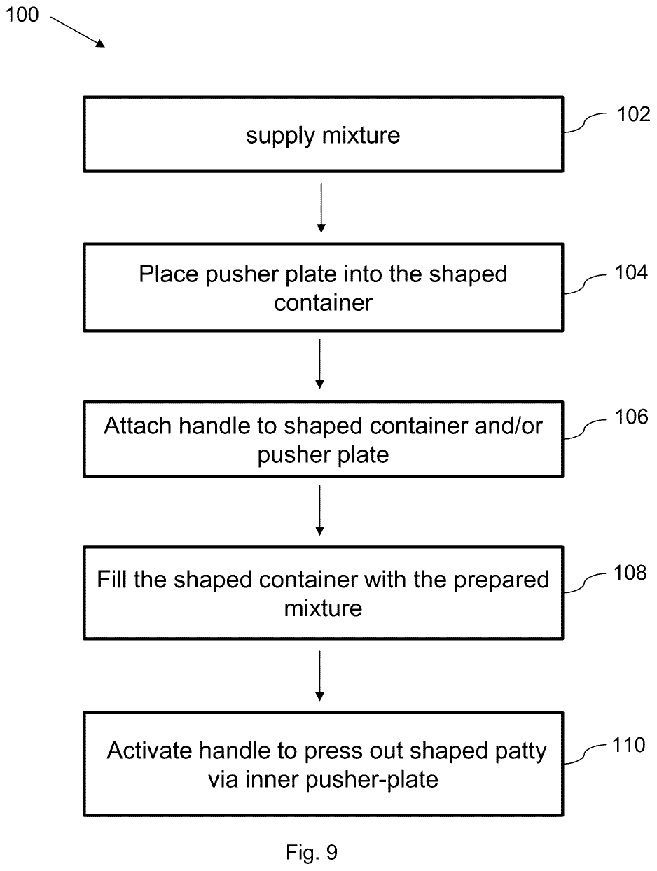

FIG. 9 is a flow chart of a method of forming shaped patties in accordance with an embodiment of the current invention. For example, in method 100, mixture is supplied 102. For example, supplying a mixture may include preparing a food-mixture (e.g., of ground foodstuff (e.g., vegetables, meat, legumes etc.)). Optionally, a pusher plate is placed 104 into a mold (e.g., a shaped container with an open distal end). For example, the pusher plate is inserted through a distal opening in the mold and/or moved distally to leave the distal opening free to insert the food-mixture. The mold and/or pusher plate may be attached 106 to the handle. For example, a coupler of the pusher plate may be exposed from the proximal side of the container and/or attached to the handle. Optionally, the container is Filled 108 with the mixture. For example, the food-mixture is pushed into the distal opening of the container up against the pusher plate and/or the food-mixture is placed on a surface and the open distal side of the container is pushed into the food-mixture. Optionally, filling 108 the container forms a patty with a proximal face against the pusher plate and/or a distal face facing the distal opening of the mold. In some embodiments, the handle is activated 110 handle to press out shaped patty. For example, activating the handle may extend the pusher plate distally and/or push the patty out of the distal opening of the mold.

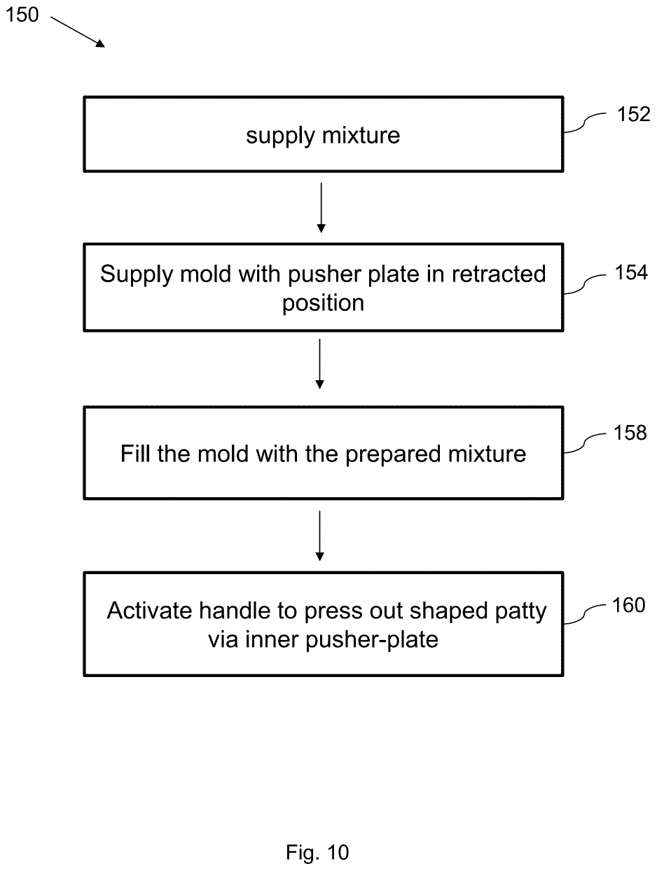

FIG. 10 is a flow chart of a method of forming shaped patties in accordance with an embodiment of the current invention. For example, in method 150, mixture is supplied 152. For example, supplying 152 the mixture may include preparing a mixture of ground foodstuff (e.g., vegetables, meat, legumes etc.).

In some embodiments, a mold (e.g., a shaped container with an open distal side) is supplied 154 with a pusher plate in a retracted position. For example, a pusher plate may be placed into the shaped container. Placing the pusher plate optionally includes, inserting the pusher plate through a distal opening in the container and/or moving the pusher plate distally to leave the distal opening free to insert the-mixture. The shaped container and/or pusher plate attached to the handle. Optionally, the handle will bias the pusher plate to the retracted position. For example, a coupler of the pusher plate may be exposed from the proximal side of the container and/or attached to the handle. Optionally, the container is Filled 158 with a food-mixture. For example, the food-mixture is pushed into the distal opening of the container up against the pusher plate and/or the food-mixture is placed on a surface and the open distal side of the container is pushed into the food-mixture. Optionally, filling 158 the container forms a patty with a proximal face against the pusher plate and/or a distal face facing the distal opening of the container. In some embodiments, the handle is Activated 160 handle to press out shaped patty. For example, activating the handle may extend the pusher plate distally and/or push the patty out of the distal opening of the container.

In some embodiments, a handle may be configured to hold a cutter and/or push it into a food mixture and/or paste to cut out a shaped patty. Optionally, the handle may be designed for one-hand use. Optionally, the handle may be configured for pushing out the patty from the shaped container. For example, pushing together levers on the handle pushes them together perpendicular to the pusher plate thereby creating increased space between the pusher plate and the proximal end of the handle. Since the handle may be fixed by a screw thread to the shaped container, then the pusher plate may be forced distally, thereby pushing out the patty.

### GENERAL

It is expected that during the life of a patent maturing from this application many relevant technologies will be developed and the scope of the terms are intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to ±10 %

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

As used herein, the terms “multiple” and “multi” are used interchangeably, and mean one or more, e.g., 1, 2, 3, 4, 5, 10, 20, etc.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A patty maker comprising:
a mold configured to shape a mixture into a patty including a distal opening for accepting the mixture; and
a pusher plate shaped and sized to fit within the mold and configured to extend distally pushing the mixture out of the distal opening of the mold.

2. The patty maker of claim 1, further comprising:
a handle protruding proximally from the mold and reversibly interconnecting between mold and the pusher plate, said handle having an inactivated configuration wherein the handle retains said pusher plate in a proximal portion of the mold and said handle configured to be activated to extend the pusher plate distally pushing the mixture out of the distal opening of the mold.

3. The patty maker of claim 2, wherein the handle is configured to be held and activated with one hand.

4. The patty maker of claim 2, wherein the mold includes a support with configured to reversibly connect to the handle.

5. The patty maker of claim 4, wherein the handle is configured to interconnect different pairs of molds and pusher plates to form patties of different shapes.

6. The patty maker of claim 5, wherein each of the different pairs of molds and pusher plates produces a patty of the same volume.

7. The patty maker of claim 4, wherein the support rigidly connects to a mount on the handle for holding the mold via the handle.

8. The patty maker of claim 7, wherein attachment between the mount and the support includes at least one attachment mechanism selected from the group consisting of a screw thread, friction element, click on interference element, magnet, snap connector, or a combination thereof.

9. The patty maker of claim 1, wherein said handle includes a connector and said pusher plate includes a coupler and wherein the connection is between the connector and the coupler.

10. The patty maker of claim 2, wherein the handle includes at least two levers.

11. The patty maker of claim 2, wherein the mold includes one or more projections configured to produce hollows in the patty.

12. The patty maker of claim 11, wherein the pusher plate includes holes matching the projections of the mold.

13. The patty maker of claim 2, wherein the pusher plate includes a stencil configured to stamp a pattern into an upper face of the patty.

14. A method of preparing a patty comprising:
supplying mold with a distal opening and a pusher plate positioned in the mold;
inserting a mixture into the distal opening of the mold; and
pressing the pusher plate towards the distal opening of the mold, thereby pushing the patty out of the mold.

15. The method claim 14, wherein a handle projects proximally from the mold and
interconnects between the mold and the pusher plate, the method further comprising:
activating the handle to press the pusher plate towards the distal opening of the mold, thereby pushing the patty out of the mold.

16. The method of claim 15, wherein said supplying includes reversibly attaching the pusher plate and the mold to the handle.

17. The method of claim 15, wherein the activating comprises squeezing at least two levers together thereby moving the pusher plate proximally away from the levers.

18. The method of claim 15, wherein the handle is designed for holding the mold and activating to push the pusher plate with one hand.

19. The method of claim 15, further comprising:
forming a first patty of a first shape with said mold and said pusher plate disconnecting said handle from said mold and said pusher plate and interconnecting another mold and anther pusher plate to form a second patty of a second shape differing from said first shape.
